(19) United States
(12) Patent Application Publication
(10) Pub. No.: US 2026/0070548 A1
(43) Pub. Date: Mar. 12, 2026

(54) Method For Operating An Assistance System Of An Ego Vehicle

(71) Applicant: Volkswagen Aktiengesellschaft, Wolfsburg (DE)

(72) Inventors: Denis Kutsenok, Wolfsburg (DE); Stefan Detering, Wolfsburg (DE); Alex Tarasow, Wolfsburg (DE)

(73) Assignee: Volkswagen Aktiengesellschaft, Wolfsburg (DE)

(21) Appl. No.: 19/291,202

(22) Filed: Aug. 5, 2025

(30) Foreign Application Priority Data
Aug. 13, 2024 (DE) 10 2024 207 718.6

(51) Int. Cl. B60W 30/14; B60W 30/16; B60W 30/18

(52) U.S. Cl. CPC B60W 30/143; B60W 30/16; B60W 30/18159; B60W 30/18163; B60W 2554/802

(57) ABSTRACT

The disclosure relates to a method for operating an assistance system of an ego vehicle for longitudinal control of the ego vehicle by means of a speed-dependent desired distance from a preceding vehicle. The disclosure provides that, in the case of a road with a branching region which forms a branching point and in which at least two turning traffic sections in a turn-off region lead in the same direction of travel, the turn-off region is subdivided into at least two adjoining control regions in which the longitudinal control of the ego vehicle is specified with different control characteristics.

### CROSS-REFERENCE TO RELATED APPLICATIONS

This application claims priority to German Patent Application DE 10 2024 207 718.6, filed on Aug. 13, 2024 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method for operating an assistance system of an ego vehicle for longitudinal control of the ego vehicle by means of a speed-dependent desired distance from a preceding vehicle.

Assistance systems are increasingly used in vehicles to control the driving operation of the vehicle in order to support, or rather relieve, the driver of the vehicle in specific driving situations or during specific movements of the vehicle. Such assistance systems are in use in a variety of embodiments in vehicles today, for example as electronic stability programs such as ESP or ESC, as an emergency brake assistant, as a lane-keeping assistant, as an overtaking assistant, as a turning assistant, as a hold assistant, as a traffic jam assistant, as a parking assistant, or for longitudinal control of the vehicle, for example, by means of adaptive cruise control (ACC), in which, depending on the speed of the vehicle in question - often referred to as the ego vehicle - a desired distance of the ego vehicle from a preceding vehicle can be set.

### SUMMARY

A need exists to provide a method for operating an assistance system of an ego vehicle for longitudinal control of the ego vehicle in which the longitudinal control is easily realized in a manner that is convenient for an operator of the ego vehicle. For example, in the case of a lane change carried out, e.g., manually in the case of transverse guidance of the vehicle performed by an operator of the ego vehicle.

The need is addressed by the subject matter of the independent claim(s). Embodiments of the invention are described in the dependent claims, the following description, and the drawings.

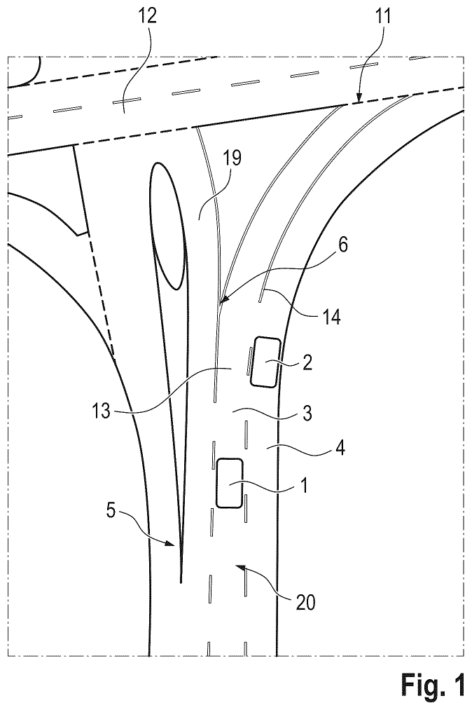

FIG. 1 shows an example traffic situation in a branching region with two turning traffic sections leading in the same direction of travel;

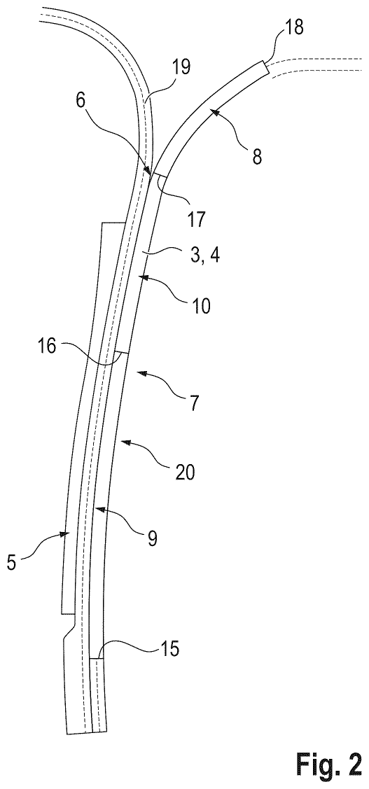

FIG. 2 shows a schematic representation of an example turn-off region with the individual control regions within the turn-off region.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method for operating an assistance system of an ego vehicle for longitudinal control of an ego vehicle by a speed-dependent desired distance from a preceding vehicle is provided, wherein the longitudinal control of the ego vehicle is performed in a manner that is user-friendly for the driver of the ego vehicle even when traffic on the road is guided in a particular manner in which a branching region forming a branching point has a turn-off region in which at least two turning traffic sections branch off in the same direction of travel.

For this purpose, the turn-off region having at least two turn lanes in the same direction of travel may be subdivided for example by the assistance system of the ego vehicle into at least two adjoining control regions. In these control regions, the longitudinal control of the ego vehicle is specified differently by the assistance system of the ego vehicle, meaning that different control characteristics for the longitudinal control of the ego vehicle are specified in the control regions within the turn-off region.

For example, the longitudinal control of the ego vehicle by the assistance system of the ego vehicle in the control regions, which are for example defined by the assistance system of the ego vehicle, within the turn-off region is specified depending on criteria characterizing a probability of a lane change of the ego vehicle to an adjacent lane, or rather to an adjacent traffic section, of the turning traffic sections.

For this purpose, for example the type of actuation of the turn signal lever of the ego vehicle is used as the first criterion for assessing the probability of a lane change of the ego vehicle to an adjacent lane, or rather to an adjacent traffic section, of the turning traffic sections. Thus, the longitudinal control of the ego vehicle in the control regions is in some embodiments specified depending on the type of turn signal activated by the driver of the ego vehicle as the first criterion characterizing the probability of a lane change of the ego vehicle and therefore with different control characteristics depending on the turn signal mode of the ego vehicle. This means that, depending on whether the driver of the ego vehicle activates a comfort turn signal as the turn signal mode by quickly tapping the turn signal lever or the driver of the ego vehicle activates a latching turn signal as the turn signal mode by actuating the turn signal lever in a manner that causes the turn signal lever to latch into place, this has corresponding effects on the specified control characteristics during longitudinal control of the ego vehicle.

In addition to the criterion of the turn signal mode as the first criterion for assessing the probability of a lane change of the ego vehicle and in some embodiments, further criteria for assessing the probability of a lane change of the ego vehicle can also be used. For example, the ego vehicle approaching the road marking that separates the turning traffic sections can be used as a further criterion characterizing the probability of a lane change of the ego vehicle, or driving over the road marking that separates the turning traffic sections can be used as a further criterion characterizing the probability of a lane change of the ego vehicle, and/or a change in the steering angle of the ego vehicle in the direction of the road marking that separates the turning traffic sections can be used as a further criterion characterizing the probability of a lane change of the ego vehicle. Additionally or alternatively and in some embodiments, the routing for a navigation route of the ego vehicle, from the navigation data of which a potential lane change of the ego vehicle can be derived, can also be used as a further criterion characterizing the probability of a lane change of the ego vehicle.

In some embodiments, the turn-off region of the road is subdivided for example by the assistance system of the ego vehicle into control regions: an approach region reaching until the branching point and a subsequent region lying after the branching point. In these control regions, the longitudinal control of the ego vehicle is then specified differently with different control characteristics by the assistance system of the ego vehicle.

In some embodiments, the approach region is also subdivided for example by the assistance system of the ego vehicle, to be precise into a near region lying immediately before the branching point and reaching until the branching point and a remote region lying before the near region at a distance from the branching point. In these control regions, too, the longitudinal control of the ego vehicle is then specified differently and therefore with different control characteristics by the assistance system of the ego vehicle.

Furthermore, when the at least two turning traffic sections transition into at least one straight-ahead traffic section, the end of the subsequent region and therefore also the end of the turn-off region is established for example by the assistance system of the ego vehicle using the point of intersection of the turning traffic sections with the at least one straight-ahead traffic section.

In some embodiments, the control regions defined by the assistance system of the ego vehicle and therefore in particular also the region boundaries of the individual control regions are established based on distance by means of navigation data stored in the ego vehicle. This means that, for the individual control regions of the turn-off region, fixed values are established using map material present in the ego vehicle. For example, these fixed vales for the region boundaries of the individual control regions are established with respect to the branching point of the branching region and thus relatively to the branching point of the branching region.

In some embodiments, the control regions defined by the assistance system of the ego vehicle and therefore in particular also the region boundaries of the individual control regions are established using the swarm data generated by other vehicles. This takes place on the basis of probability considerations and therefore a frequency, determined in the case of other vehicles, of a lane change within the turn-off region, from which in particular the individual different control regions within the turn-off region can then also be derived. In particular, the region boundaries of the individual control regions can then also be dynamically adapted to the current conditions.

For example, in the method according to the teachings herein, early control of the ego vehicle relative to a preceding vehicle as an adjacent lane object in another turning traffic section in the turn-off region is specified by the assistance system of the ego vehicle when a comfort turn signal of the ego vehicle is activated in the remote region of the turn-off region. This is thus interpreted as a desire of the driver of the ego vehicle to perform a lane change of the ego vehicle to an adjacent lane of the turning traffic section, in response to which longitudinal control of the ego vehicle with respect to a preceding vehicle can then be performed.

Furthermore, in the method, for example early control of the ego vehicle relative to a preceding vehicle as an adjacent lane object in another turning traffic section in the turn-off region is specified by the assistance system of the ego vehicle when a latching turn signal of the ego vehicle is activated in the remote region of the turn-off region and at least one more of the mentioned criteria characterizing a probability of a lane change of the ego vehicle is present.

In the method, for example early control of the ego vehicle relative to a preceding vehicle as an adjacent lane object in another turning traffic section in the turn-off region is specified by the assistance system of the ego vehicle when an actuation of the turn signal lever, performed independently of the turn signal mode, of the ego vehicle by the driver of the ego vehicle takes place in the near region of the turn-off region or in the subsequent region of the turn-off region and at least one more of the mentioned criteria characterizing a probability of a lane change of the ego vehicle is present.

Furthermore, an assistance system of the ego vehicle, configured as a distance assistant of the ego vehicle for longitudinal control of the ego vehicle, and an ego vehicle which has such an assistance system for longitudinal control of the ego vehicle are also taught herein.

By means of the proposed method for operating an assistance system of an ego vehicle for longitudinal control of the ego vehicle, beneficially, longitudinal control of the ego vehicle that is user-friendly and therefore convenient for a driver of the ego vehicle can be performed easily in a manner that is intuitively understandable even in a traffic situation that is often unclear in a branching region which has a turn-off region with at least two turning traffic sections leading in the same direction of travel. In the embodiments described herein, the described components of the embodiments each represent individual features that are to be considered independent of one another, in the combination as shown or described, and in combinations other than shown or described. In addition, the described embodiments can also be supplemented by features other than those described.

Specific references to components, process steps, and other elements are not intended to be limiting. Further, it is understood that like parts bear the same or similar reference numerals when referring to alternate FIGS.

Reference will now be made to the drawings in which the various elements of embodiments will be given numerical designations and in which further embodiments will be discussed.

By means of the assistance system of the ego vehicle, an analysis regarding the occurrence of branching regions 5 on the route of travel of the ego vehicle 1 is carried out on the basis of the map material stored in the ego vehicle 1, in which a turn-off region 20 with at least two turn lanes, or rather turning traffic sections 3, 4, leading in the same direction of travel is formed. For example, such an analysis regarding the occurrence of branching regions 5 with a turn-off region 20 having at least two turn lanes, or rather turning traffic sections 3, 4, leading in the same direction of travel is performed on the route of travel of the ego vehicle 1 in a region of, for example, at least 150 m to 500 m lying on the route of travel in front of the ego vehicle 1.

In FIG. 1, such a traffic situation is shown with a branching region 5 which has a turn-off region 20 and in which, on the road 13 in the turn-off region 20, two turn lanes, or rather turning traffic sections 3, 4, branch off from the straight-ahead lane, or rather from the straight-ahead traffic section 19, to the right as right-turn lanes in the same direction of travel. In the branching region 5, the two turn lanes, or rather turning traffic sections 3, 4, are routed together next to each other until the end of the branching region 5, at which they open at the junction 11 into the through-lane, or rather the through-traffic section 12, and transition into this through-traffic section 12, or rather merge into this through-traffic section 12. Within the turn-off region 20 with the two turn lanes, or rather turning traffic sections 3, 4, the ego vehicle 1 is located in the left turn lane, or rather in the left turning traffic section 3. Furthermore, within the turn-off region 20 with the two turn lanes, or rather turning traffic sections 3, 4, a vehicle 2 preceding the ego vehicle 1 is also located in front of the ego vehicle 1 in the right turn lane, or rather in the right turning traffic section 4. In order for the assistance system of the ego vehicle 1 to provide convenient longitudinal control of the ego vehicle 1 that is user-friendly for the driver of the ego vehicle 1 also in the branching region 5 and in particular in the turn-off region 20, the turn-off region 20 is subdivided into multiple control regions 7, 8, 9, 10 in which different control characteristics for the longitudinal control of the ego vehicle 1 by the assistance system of the ego vehicle 1 are specified.

According to FIG. 2, two adjoining control regions 7, 8 that are in particular related to the branching point 6 of the branching region 5 are established for the turn-off region 20: an approach region 7 lying before the branching point 6 of the branching region 5 and a subsequent region 8 lying after the branching point 6 of the branching region 5. The start of the approach region 7, or rather the beginning 15 of the approach region 7, is established based on distance, for example, at a distance of 100 m to 200 m before the branching point 6 of the branching region 5 on the basis of navigation data present in the ego vehicle 1. In particular, the approach region 7 begins at the point at which the turn-off region 20 begins and the two turn lanes, or rather turning traffic sections 3, 4, branch off, meaning that the beginning 15 of the approach region 7 lies at the point at which the two turn lanes, or rather turning traffic sections 3, 4, are separated from the straight-ahead lane, or rather from the straight-ahead traffic section 19. The end of the approach region 7, or rather the end 17 of the approach region 7, and therefore simultaneously the start of the subsequent region 8, or rather the beginning 17 of the subsequent region 8, is established by the branching point 6 of the branching region 5 and coincides in particular with the branching point 6 of the branching region 5. The end of the subsequent region 8, or rather the end 18 of the subsequent region 7, is established based on distance, for example, at a distance of 10 m to 20 m behind the branching point 6 of the branching region 5 on the basis of navigation data present in the ego vehicle 1. In particular, however, the end of the subsequent region 8 is established using the point of intersection of the two turning traffic sections 3, 4 with the through-traffic section 12, meaning that the end of the subsequent region 8 lies as a result at the junction 11 of the two turning traffic sections 3, 4 with the through-traffic section 12.

The approach region 7 is for example additionally subdivided into two adjoining control regions 9, 10, to be precise into a near region 10 lying immediately before the branching point 6 of the branching region 5 and a remote region 9 adjoining the near region 10 and lying before the near region 10 at a distance from the branching point 6 of the branching region 5. The beginning 15 of the remote region 9 therefore corresponds to the beginning 15 of the approach region 7, and the end 17 of the near region 10 therefore corresponds to the end 17 of the approach region 7. For example, when the approach region 7 is subdivided, the end 16 of the remote region 9 and therefore simultaneously the beginning 16 of the near region 10 is established based on distance at a distance of 50 m before the branching point 6 of the branching region 5 on the basis of navigation data present in the ego vehicle 1.

To establish the region boundaries 15, 16, 17, 18 of the control regions 7, 8, 9, 10 or also to determine the region boundaries 15, 16, 17, 18, defined based on distance, of the control regions 7, 8, 9, 10 more precisely, swarm data obtained by other vehicles driving along the turn-off region 20 can also be used. This means that, from this data, it is established at which position vehicles in the turn-off region 20 usually enter the two turn lanes, or rather turning traffic sections 3, 4, and whether and at which position these vehicles usually perform a lane change within the turn-off region 20 from one turning traffic section 3, 4 to the other turning traffic section 4, 3.

Depending on the control regions 7, 8, 9, 10 driven along by the ego vehicle 1 in the turn-off region 20, the longitudinal control of the ego vehicle 1 is specified differently, meaning carried out with different control characteristics, by the assistance system of the ego vehicle 1. In particular, the applied turn signal mode of the ego vehicle 1 in the turn-off region 20 is taken into account here during the corresponding implementation of the longitudinal control of the ego vehicle 1.

When driving along the remote region 9 of the approach region 7, the ego vehicle 1 is located in the turn-off region 20 still at a greater distance before the branching point 6 of the branching region 5. When a comfort turn signal of the ego vehicle 1 is activated within the remote region 9 of the approach region 7, meaning in a turn signal mode in which the turn signal lever of the ego vehicle 1 is tapped only once and the direction of travel indicator, or rather the turn signal, of the ego vehicle 1 then flashes for a short time, for example flashes three times, this is assumed to mean that the driver of the ego vehicle 1 wishes to perform a lane change from the current turn lane, or rather from the current turning traffic section 3, to the other turn lane, or rather to the other turning traffic section 4. As a result, an early response of the assistance system for longitudinal control of the ego vehicle 1 to the preceding vehicle 2 as an adjacent lane object in the turn lane, or rather to the turning traffic section 4, is performed. When a latching turn signal of the ego vehicle 1 is activated within the remote region 9 of the approach region 7, meaning in a turn signal mode in which the turn signal lever of the ego vehicle 1 latches into place and remains latched and the direction of travel indicator, or rather the turn signal, of the ego vehicle 1 therefore flashes until the turn signal lever of the ego vehicle 1 is reset to the starting position, this is assumed to mean that the driver of the ego vehicle 1 would simply like to indicate a wish to turn from the straight-ahead lane, or rather from the straight-ahead traffic section 19, to the turn lane, or rather to the turning traffic section 3. In order to generate a response of the assistance system for longitudinal control of the ego vehicle 1 to the preceding vehicle 2 in the turn lane, or rather in the turning traffic section 4, in addition to the actuation of the turn signal lever of the ego vehicle 1 in the latching turn signal mode, the presence of at least one further criterion characterizing a high probability of a lane change of the ego vehicle 1 is also required. Such a criterion for a high probability of a lane change of the ego vehicle 1 can be, for example, the ego vehicle 1 approaching the road marking 14 that separates the two turn lanes, or rather turning traffic sections 3, 4, or the ego vehicle 1 driving over this road marking 14 or a change in the steering angle of the ego vehicle 1 in the direction of the road marking 14. If at least one of these further criteria for a high probability of a lane change of the ego vehicle 1 is present, an early response of the assistance system for longitudinal control of the ego vehicle 1 to the preceding vehicle 2 as an adjacent lane object in the turn lane, or rather in the turning traffic section 4, is also performed.

If, however, the direction of travel indicator, or rather the turn signal, of the ego vehicle 1 has already been activated before driving along the remote region 9 and therefore also before driving along the approach region 7 and the ego vehicle 1 is therefore already signaling a turn when driving into the remote region 9 and therefore also already signaling a turn when driving into the approach region 7, in this case an early response of the assistance system for longitudinal control of the ego vehicle 1 to the preceding vehicle 2 as an adjacent lane object in the turn lane, or rather in the turning traffic section 4, is also performed.

When driving along the near region 10 of the approach region 7, the ego vehicle 1 is located in the turn-off region 20 at a very short distance before the branching point 6 of the branching region 5. When the turn signal lever of the ego vehicle 1 is actuated within the near region 10 of the approach region 7, a response of the assistance system for longitudinal control of the ego vehicle 1 to the preceding vehicle 2 as an adjacent lane object in the turn lane, or rather in the turning traffic section 3, is only performed when, independently of the selected turn signal mode, at least one further criterion characterizing a high probability of a lane change of the ego vehicle 1 is present when the turn signal lever of the ego vehicle 1 is actuated. Such criteria for a high probability of a lane change of the ego vehicle 1 can in turn be the mentioned criteria.

In an analogous manner, when driving along the subsequent region 8, a response of the assistance system for longitudinal control of the ego vehicle 1 to the preceding vehicle 2 as an adjacent lane object in the turn lane, or rather in the turning traffic section 3, is only performed when, independently of the selected turn signal mode, at least one further criterion characterizing a high probability of a lane change of the ego vehicle 1 is present when the turn signal lever of the ego vehicle 1 is actuated. Such criteria for a high probability of a lane change of the ego vehicle 1 can in turn be the mentioned criteria.

If the direction of travel indicator, or rather the turn signal, of the ego vehicle 1 has been activated within the turn-off region 20 and therefore in the approach region 7 or in the subsequent region 8 and is also still active when departing from the subsequent region 8 and therefore when departing from the turn-off region 20, the control characteristics specified by the assistance system of the ego vehicle 1 within the turn-off region 20 remain. This means that, after departing from the subsequent region 8 and therefore after departing from the turn-off region 20, a response of the assistance system for longitudinal control of the ego vehicle 1 to a preceding vehicle is performed only when, in addition to the actuation of the turn signal lever of the ego vehicle 1, at least one further criterion characterizing a high probability of a lane change of the ego vehicle 1 is present. Only when the direction of travel indicator, or rather the turn signal, of the ego vehicle 1 has been deactivated again is the standard longitudinal control of the ego vehicle 1 specified again by the assistance system of the ego vehicle 1.

### LIST OF REFERENCE NUMERALS

1 Ego vehicle
2 Preceding vehicle
3 Turn lane
4 Adjacent lane
5 Branching region
6 Branching point
7 Approach region
8 Subsequent region
9 Remote region
10 Near region
11 Junction
12 Through-traffic section
13 Road
14 Lane separation
15 Start of remote region
16 End of remote region/start of near region
17 End of near region/start of subsequent region
18 End of subsequent region
19 Straight-ahead lane
20 Turn-off region

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example”or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for operating an assistance system of an ego vehicle for longitudinal control of the ego vehicle using a speed-dependent desired distance from a preceding vehicle, comprising:
in the case of a road with a branching region which forms a branching point and in which at least two turning traffic sections in a turn-off region lead in the same direction of travel, subdividing the turn-off region into at least two adjoining control regions; and
operating the longitudinal control of the ego vehicle with different control characteristics in the at least two adjoining control regions.

2. The method of claim 1, wherein the turn-off region of the branching region is subdivided into an approach region before the branching point reaching until the branching point and a subsequent region lying after the branching point as control regions in which the longitudinal control of the ego vehicle is operated with different control characteristics.

3. The method of claim 2, wherein the approach region is subdivided into a near region arranged immediately before the branching point and extending until the branching point and a remote region arranged before the near region at a distance from the branching point, in which near region and remote region the longitudinal control of the ego vehicle is operated with different control characteristics.

4. The method of claim 2, wherein, when the at least two turning traffic sections of the turn-off region transition at the end of the turn-off region into at least one through-traffic section, the end of the subsequent region is established using the point of intersection of the at least two turning traffic sections with the at least one through-traffic section.

5. The method of claim 1, wherein the control regions are established based on distance using navigation data stored in the ego vehicle and/or are established based on probability considerations on the basis of the swarm data generated by other vehicles.

6. The method of claim 1, wherein the longitudinal control of the ego vehicle is operated in the control regions depending on criteria characterizing a probability of a lane change of the ego vehicle.

7. The method of claim 6, wherein the longitudinal control of the ego vehicle is operated in the control regions depending on the type of actuation of the turn signal lever of the ego vehicle.

8. The method of claim 6, wherein longitudinal control of the ego vehicle relative to a preceding vehicle in another turning traffic section in the branching region is specified when a comfort turn signal of the ego vehicle is activated in the remote region or when a latching turn signal of the ego vehicle is activated in the remote region and at least one further criterion characterizing a probability of a lane change of the ego vehicle is present or when the turn signal lever of the ego vehicle is actuated in the near region or in the subsequent region and at least one further criterion characterizing a probability of a lane change of the ego vehicle is present.

9. A method for operating an assistance system, configured as a distance assistant system of the ego vehicle, wherein the assistance system is configured to conduct the method of claim 1.

10. A vehicle with an assistance system, the assistance system being configured to:
in the case of a road with a branching region which forms a branching point and in which at least two turning traffic sections in a turn-off region lead in the same direction of travel, subdivide the turn-off region into at least two adjoining control regions; and
operate the longitudinal control of the ego vehicle with different control characteristics in the at least two adjoining control regions.

11. The method of claim 3, wherein, when the at least two turning traffic sections of the turn-off region transition at the end of the turn-off region into at least one through-traffic section, the end of the subsequent region is established using the point of intersection of the at least two turning traffic sections with the at least one through-traffic section.

12. The method of claim 2, wherein the control regions are established based on distance using navigation data stored in the ego vehicle and/or are established based on probability considerations on the basis of the swarm data generated by other vehicles.

13. The method of claim 3, wherein the control regions are established based on distance using navigation data stored in the ego vehicle and/or are established based on probability considerations on the basis of the swarm data generated by other vehicles.

14. The method of claim 4, wherein the control regions are established based on distance using navigation data stored in the ego vehicle and/or are established based on probability considerations on the basis of the swarm data generated by other vehicles.

15. The method of claim 2, wherein the longitudinal control of the ego vehicle is operated in the control regions depending on criteria characterizing a probability of a lane change of the ego vehicle.

16. The method of claim 3, wherein the longitudinal control of the ego vehicle is operated in the control regions depending on criteria characterizing a probability of a lane change of the ego vehicle.

17. The method of claim 4, wherein the longitudinal control of the ego vehicle is operated in the control regions depending on criteria characterizing a probability of a lane change of the ego vehicle.

18. The method of claim 5, wherein the longitudinal control of the ego vehicle is operated in the control regions depending on criteria characterizing a probability of a lane change of the ego vehicle.

19. The method of claim 7, wherein longitudinal control of the ego vehicle relative to a preceding vehicle in another turning traffic section in the branching region is specified when a comfort turn signal of the ego vehicle is activated in the remote region or when a latching turn signal of the ego vehicle is activated in the remote region and at least one further criterion characterizing a probability of a lane change of the ego vehicle is present or when the turn signal lever of the ego vehicle is actuated in the near region or in the subsequent region and at least one further criterion characterizing a probability of a lane change of the ego vehicle is present.
